(19) United States
(12) Patent Application Publication
(10) Pub. No.: US 2011/0287186 A1
(43) Pub. Date: Nov. 24, 2011

(54) Method for making a phoshate-treated galvanized steel sheet

(75) Inventors: Satoru Ando, Fukuyama (JP); Chiyoko Tada, Chiba (JP); Hiroki Nakamaru, Chiba (JP); Kenichi Sasaki, Chiba (JP); Nobue Fujibayashi, Kawasaki (JP); Akira Matsuzaki, Kawasaki (JP)

(73) Assignee: JFE STEEL CORPORATION, Tokyo (JP)

(21) Appl. No.: 13/136,296

(22) Filed: Jul. 28, 2011

Related U.S. Application Data
(62) Division of application No. 12/310,289, filed on Feb. 19, 2009.

(30) Foreign Application Priority Data
Oct. 31, 2006 (JP) 2006-295589

(51) Int. Cl. B05D 7/14; B05D 5/00; B05D 3/00

(52) U.S. Cl. 427/299

(57) ABSTRACT

A method for making a phosphate-treated galvanized steel sheet, including forming a phosphate film on the surface of a galvanized layer of a galvanized steel sheet using a phosphate treatment solution containing Zn²⁺ and Mg²⁺ so as to satisfy 2.0<Zn²⁺≦5.0 g/L, 2.0≦Mg²⁺≦5.0 g/L, and 0.4≦Mg²⁺/Zn²⁺≦2.5, and satisfying 0.020≦free acidity/total acidity<0.10. The method allows for the quick formation of a uniform phosphate film, whereby a phosphate-treated galvanized steel sheet having excellent corrosion resistance and blackening resistance is obtained.

### CROSS-REFERENCE TO RELATED APPLICATIONS

This application is a divisional application of application Ser. No. 12/310,289 filed Feb. 19, 2009, which is the United States national phase application under 35 USC 371 of International application PCT/JP2007/071590 filed Oct. 31, 2007. The entire contents of each of application Ser. No. 12/310,289 and International application PCT/JP2007/071590 are hereby incorporated by reference herein.

### TECHNICAL FIELD

The present invention relates to a surface-treated steel sheet used mainly for building and home appliance applications, and specifically to a phosphate-treated galvanized steel sheet suitable as a steel substrate to be coated, and a method for making the same.

### BACKGROUND ART

Galvanized steel sheets coated with zinc or zinc alloys are used in areas requiring corrosion resistance for building and home appliance applications. Such galvanized steel sheet is rarely used as it is. In usual cases, a coating is applied onto the galvanized layer of the sheet. Further, before the application of a coating, the sheet is usually subjected to chemical treatment such as phosphate treatment or chromate treatment:

The phosphate treatment is carried out by contacting an acidic solution containing phosphate ions with a galvanized steel sheet to allow them to react, thereby forming a crystalline film composed mainly of zinc phosphate on the coating surface. The phosphate treatment improves coating adhesion, whereby primary coating properties stable to various coatings are made available. Therefore, galvanized steel sheets treated with phosphate are widely used as steel substrates to be coated for building and home appliance applications. Further, in recent years, in order to improve the corrosion resistance of phosphate films, techniques for forming a zinc phosphate film containing Mg have been disclosed in many patent documents.

For example, Japanese Unexamined Patent Application Publication No. 2002-285346 discloses a zinc phosphate-treated galvanized steel sheet with excellent corrosion resistance and color tone, the steel sheet having a zinc phosphate film containing 2.0% or more of Mg and 0.01 to 1% of at least one element selected from Ni, Co, and Cu at a coating weight of 0.7 g/m² or more.

However, under the technique, the zinc phosphate film contains a large amount of Mg, so that the surface of the steel sheet coated with the phosphate film may be discolored black, or blackened when exposed to high temperatures and humidity. There is another problem that the color tone of the zinc phosphate film is dark because the film contains Co, and/or Cu at high concentrations.

Japanese Patent No. 2680618 discloses a technique for preventing the formation of spots of phosphate crystals through the treatment of a galvanized steel or an aluminum-zinc coated steel sheet with a magnesium zinc phosphate-based aqueous solution containing 0.4 to 2.0 g/L of Zn, 0.4 to 5.0 g/L of Mg, and 0.05 to 2.0 g/L of Ni, and 8.0 to 20.0 g/L of P₂O₅, wherein the ratio of the free acid content to the total acid content (free acidity/total acidity) in the solution is from 0.02 to 0.15.

Under the technique, in order to densely form phosphate crystals, the treatment requires a relatively long period of time of 20 seconds to 10 minutes. When the treatment is followed by aftertreatment such as electroplating, the above treatment time is preferably as short as possible from the viewpoint of production efficiency, but phosphate crystals tend to be incompletely formed with a short treatment such as several seconds, which may result in local vacancies of phosphate crystals.

Japanese Patent No. 2770860 discloses a technique for quickly forming a phosphate film with a white color tone through the treatment with a phosphate aqueous solution containing 0.5 to 5.0 g/L of Zn, 0.3 to 3.0 g/L of Mg, and 3.0 to 20.0 g/L of P₂O₅, wherein the ratio of the free acid content to the total acid content (free acidity/total acidity) in the solution is from 0.1 to 0.4.

Under the technique, the free acid concentration is increased thereby enhancing the etching effect on zinc in a galvanized steel sheet. However, continuous treatment of a steel sheet tends to result in development of streaks, depending on the surface state of the galvanized steel sheet. This is likely due to the fact that the difference between the levels of local reactivity of the zinc surface layer becomes obvious through the treatment with a high etching effect, which results in the development of macroscopic flaws.

The object of the invention is to provide a method for making a phosphate-treated galvanized steel sheet which allows the quick formation of a uniform phosphate film, and a phosphate-treated galvanized steel sheet having excellent corrosion resistance and blackening resistance made by the method.

### DISCLOSURE OF INVENTION

An aspect of the present invention is a method for making a phosphate-treated galvanized steel sheet, including forming a phosphate film on the surface of a galvanized layer of a galvanized steel sheet using a phosphate treatment solution containing Zn²⁺ and Mg²⁺ so as to satisfy 2.0<Zn²⁺≦5.0 g/L, 2.0≦Mg²⁺≦5.0 g/L, and 0.4≦Mg²⁺/Zn²⁺≦2.5, and satisfying 0.020≦free acidity/total acidity<0.10.

In the making method, the phosphate film is preferably formed by contacting the galvanized layer surface with the phosphate treatment solution for 3 to 15 seconds.

Another aspect of the present invention is a phosphate-treated galvanized steel sheet made by any of the above making methods, the galvanized steel sheet having thereon a phosphate film containing Mg in an amount of 0.2≦Mg<2.0% by mass at a coating weight of 0.2 to 3.0 g/m².

Yet another aspect of the present invention is a method for making a phosphate-treated galvanized steel sheet including treating a galvanized steel sheet with a phosphate treatment solution to form a phosphate film on the surface of the galvanized steel sheet, wherein the phosphate treatment solution contains Zn²⁺ in an amount of more than 2.0 g/L and 5.0 g/L or less, Mg²⁺ in an amount of from 2.0 to 5.0 g/L, the concentration ratio of the Mg²⁺ to Zn²⁺ (Mg²⁺/Zn²⁺) is from 0.4 to 2.5, and the ratio of the free acidity to the total acidity in the treatment solution is 0.020 or more and less than 0.10.

### BEST MODE FOR CARRYING OUT THE INVENTION

As a result of dedicated research to solve the above problems, the inventors have found that a uniform phosphate film is quickly formed on a galvanized steel sheet through the use of a phosphate treatment solution containing a zinc ion and a magnesium ion, wherein the zinc ion level, the magnesium ion level, and the concentration ratio of the magnesium ion to the zinc ion are within specific ranges, and the ratio of the free acidity to the total acidity is optimum. They have also found that the resultant phosphate-treated galvanized steel sheet has excellent corrosion resistance and blackening resistance. The present invention has been accomplished on the basis of the findings.

The structure of the present invention and the reason for the numerical limitation of each essential feature are described below.

The phosphate-treated galvanized steel sheet obtained by the method of the present invention is composed of a galvanized steel sheet having thereon a phosphate film containing 0.2% or more and less than 2.0% by mass of Mg, at a coating weight of 0.2 to 3.0 g/m².

(Galvanization)

The galvanized steel sheet as the steel substrate for the steel sheet of the present invention may be any galvanized steel sheet, for example, a hot dip galvanized steel sheet, an electrogalvanized steel sheet, a galvannealed steel sheet, an aluminum-zinc alloy-coated steel sheet (for example, a molten zinc-55% by mass aluminum alloy-coated steel sheet, or a molten zinc-5% by mass aluminum alloy-coated steel sheet), an iron-zinc alloy-coated steel sheet, a nickel-zinc alloy-coated steel sheet, or a nickel-zinc alloy-coated steel sheet after blackening treatment. The steel sheet as the substrate is not particularly limited as long as it is suitable for use as a galvanized steel sheet, and may be appropriately selected according to the intended use. The coating weight of the galvanized layer may be appropriately selected according to the intended use, and is preferably from 1 to 100 g/m². When the coating weight is 1 g/m² or more, sufficient corrosion resistance is achieved. However, a coating weight of more than 100 g/m² is wasteful, in terms of cost. The coating weight is more preferably from 5 to 70 g/m².

(Phosphate Film)

The galvanized steel sheet has on at least one side thereof a phosphate film containing 0.2% by mass or more and less than 2.0% by mass of Mg, at a coating weight of 0.2 to 3.0 g/m².

The phosphate film is formed mainly for improving the adhesion between the galvanized layer and coating, and more preferably improves corrosion resistance as well as the adhesion. The Mg content of the phosphate film is preferably 0.2% by mass or more and less than 2.0% by mass. When the content is 0.2% by mass or more, sufficient corrosion resistance is achieved, and when the content is less than 2.0% by mass, excellent blackening resistance is achieved. The Mg content is more preferably from 0.5 to 1.0% by mass. The phosphate film may contain unavoidable impurities such as Ni, Mn, and Co within a range of 0.01 to 0.4% by mass.

The coating weight of the phosphate film is preferably from 0.2 to 3.0 g/m². When the coating weight is 0.2 g/m² or more, sufficient corrosion resistance is achieved, and when the coating weight is 3.0 g/m² or less, coarsening of the phosphate crystals in the phosphate film is rather inhibited, which results in the improvement of the coating adhesion.

The phosphate film is formed by contacting the surface of the galvanized layer with the below-described phosphate treatment solution. The contact method is not particularly limited, and may be an ordinary method such as spraying or immersion.

The treatment time with the phosphate treatment solution is preferably from 3 to 15 seconds. When the treatment time is 3 seconds or more, the phosphate film is readily formed, and when the treatment time is 15 seconds or less, etching by the phosphate treatment solution is rather inhibited, which facilitates the formation of a more uniform phosphate film.

Before the formation of the phosphate film, it is preferable that the galvanized layer be subjected to surface conditioning treatment using a colloidal titanium active treatment agent. Examples of the colloidal titanium active treatment agent include “PREPALENE ZN” manufactured by Nihon Parkerizing Co., Ltd. The surface conditioning treatment may be carried out by spraying the treatment agent on the surface of the galvanized layer.

The method of the present invention for making a phosphate-treated galvanized steel sheet includes forming a phosphate film on the surface of a galvanized layer of a galvanized steel sheet using a phosphate treatment solution containing Zn²⁺ and Mg²⁺ so as to satisfy 2.0<Zn²⁺≦5.0 g/L, 2.0≦Mg²⁺≦5.0 g/L, and 0.4≦Mg²⁺/Zn²⁺≦2.5, and satisfying 0.020≦free acidity/total acidity<0.10. In the present description, the liter unit is expressed as “L”.

2.0<Zn²⁺≦5.0 g/L

Zn²⁺ is an essential component for forming phosphate crystals, so that the Zn²⁺ concentration in the phosphate treatment solution must be more than 2.0 g/L and 5.0 g/L or less, and is more preferably from 3.0 to 5.0 g/L. If the concentration is 2.0 g/L or less, the phosphate insufficiently deposits, which results in the formation of a nonuniform phosphate film locally devoid of phosphate crystals, and if more than 5.0 g/L, the phosphate crystals are coarsened, which results in the failure to achieve sufficient corrosion resistance of the phosphate film.

2.0≦Mg²⁺≦5.0 g/L

Mg²⁺ is an essential component for improving the corrosion resistance of the phosphate film, so that the Mg²⁺ concentration in the phosphate treatment solution must be from 2.0 to 5.0 g/L, and is more preferably from 2.5 to 5.0 g/L. If the concentration is less than 2.0 g/L, inclusion of the magnesium component is so low that the corrosion resistance of the zinc phosphate film deteriorates, and if more than 5.0 g/L, the content of the magnesium components is so high that the blackening resistance of the zinc phosphate film deteriorates. The Mg²⁺ concentration varies depending on the concentration ratio of Mg²⁺ to Zn²⁺ (Mg²⁺/Zn²⁺) in the below-described phosphate aqueous solution, so that the Mg²⁺ concentration must be adjusted within an appropriate range of Mg²⁺/Zn²⁺.

0.4≦Mg²⁺/Zn²⁺≦2.5

In order to form a phosphate film containing an appropriate amount of Mg, in the present invention, the concentration ratio of the magnesium ion to the zinc ion in the phosphate treatment solution (Mg²⁺/Zn²⁺) is defined as from 0.4 to 2.5, and more preferably from 0.8 to 1.2. If Mg²⁺/Zn²⁺ is less than 0.4, the Mg²⁺ concentration in the treatment solution is less than 2.0 g/L, so that Zn is preferentially taken into the phosphate film of the product, which results in a decrease of the ratio of Mg to Zn that deteriorates the corrosion resistance of the zinc phosphate film. On the other hand, if Mg²⁺/Zn²⁺ is more than 2.5, the Mg²⁺ concentration in the treatment solution is more than 5.0 g/L, the ratio of Mg to Zn in the phosphate film of the product is out of the appropriate range, and the blackening resistance of the zinc phosphate film deteriorates.

In addition to the above-described conditions, the phosphate treatment solution preferably has a temperature of from 30 to 70° C., and a pH of from 1.0 to 2.5. The reasons for these ranges are as follows.

Firstly, under the conditions, the Mg salt readily dissolves in the phosphate treatment solution, which facilitates optimization of the Mg²⁺ concentration in the solution.

Secondly, the phosphate treatment solution is more reactive at a liquid temperature of 30° C. or higher, which facilitates quick formation of a uniform film. In addition, when the liquid temperature is 70° C. or lower, etching is rather inhibited and the phosphate readily deposits, which markedly facilitates the control of the treatment time. Further, when the pH is 1.0 or more, etching rarely occurs and the film readily deposits, which facilitates the control of the treatment time as described above. In addition, when the pH is 2.5 or less, the treatment solution is stable.

The inventors also studied the selection of the anion countering Mg²⁺ in the treatment solution. The anion is preferably a nitrate ion. The anion may be a hydroxide ion, a carbonate ion, or a sulfate ion, but Mg salts of these ions have rather inferior solubility. When a chloride ion is used as the anion, the Mg salt has sufficient solubility, but chlorine ions may be included in the phosphate treatment solution concurrently with Mg²⁺ to cause a deleterious effect. On the other hand, a nitrate ion has an oxidative effect and is less likely to remain in the film components than other anions, and thus further improves the performance of the phosphate film. Accordingly, the anion is preferably a nitrate ion, and the Mg ion source in the treatment solution is preferably magnesium nitrate. The phosphate treatment solution used in the present invention is preferably a commercial treatment solution containing a zinc ion, a phosphate ion, and other additives such as a promoter, and examples of the treatment solution include “PB3312M” (trade name) manufactured by Nihon Parkerizing Co., Ltd. mixed with a specified amount of the nitrate ion.

0.020≦free acidity/total acidity<0.10

The phosphate film is formed as follows: the pH at the solid-liquid interface of the treatment solution is increased by the etching action of the free orthophosphoric acid (free acid) in the treatment solution on the plated surface, and the concentration equilibrium between zinc dihydrogenphosphate (Zn(H₂PO₄)₂) and orthophosphoric acid (H₃PO₄) in the treatment solution changes, so that the zinc dihydrogenphosphate deposits as zinc phosphate crystals containing magnesium. Accordingly, in the formation of the phosphate film, the free acid plays a very important role. Accordingly, the inventors focused attention on the etching action of the free acid, and eagerly studied a method for forming a uniform phosphate film through short treatment (about 3 to 15 seconds).

As a result of this, they have found that (i) the increase of the free acid concentration enhances the etching effect on zinc plating, and the surface state becomes nonuniform by the degreasing and surface conditioning processes conducted as pretreatment before the phosphate treatment, so that an uneven phosphate film is formed, and that (ii) the increase of the free acid concentration hinders the deposition of zinc phosphate crystals, so that no phosphate film is formed in some areas with short treatment for several seconds. As a result of further research, they have also found that the optimization of the ratio of the free acidity to the total acidity in a lower range than in the prior art allows the deposition of phosphate crystals on the same level as in the prior art while controlling the etching effect, whereby a uniform phosphate film is quickly formed.

The free acid (orthophosphoric acid) concentration is preferably from 0.5 to 3.4 in terms of free acidity, and more preferably from 1.0 to 3.0. The total acidity is preferably from 20 to 26, which must include the described free acidity.

The ratio of the free acidity to the total acidity (free acidity/total acidity) must be 0.020 or more and less than 0.10, and is more preferably from 0.035 to 0.096. If the ratio is less than 0.020, the free acid concentration is so low that the etching effect on zinc is poor, and reaction necessary for deposition of phosphate crystals is rather hindered, which results in the failure to form a sufficient phosphate film. In addition, stability of the phosphate treatment solution deteriorates, and zinc and solids, which are likely phosphate compounds containing iron occurring as an impurity, deposit and disperse in the treatment solution. On the other hand, if the concentration is 0.10 or more, after short treatment for few seconds, the phosphate film may have flaws due to the nonuniform surface state of zinc.

The term free acidity is determined as follows: several drops of bromophenol blue as an indicator are added to 10 ml of the phosphate treatment solution, the treatment solution is titrated with 0.1 N caustic soda, and the amount of 0.1 N caustic soda (ml) used for the neutralization is expressed as an absolute number. In the same manner, the total acidity is determined as follows: several drops of phenolphthalein as the indicator are added to 10 ml of the phosphate treatment solution, the treatment solution is titrated with 0.1 N caustic soda, and the amount of 0.1 N caustic soda (ml) used for the neutralization is expressed as an absolute number.

The above-described embodiment is only an example of the embodiments of the present invention, and various modifications thereof may be made.

### EXAMPLES

Examples of the present invention are described below.

### Examples 1 to 16 and Comparative Examples 1 to 9

A cold rolled steel sheet having a thickness of 1.0 mm was subjected to, as pretreatment, electrolytic degreasing for 30 seconds at a current density of 5 A/dm² in an alkali degreasing liquid (liquid temperature: 70° C.) containing sodium orthosilicate (60 g/L), with stainless steel as the counter electrode. The steel sheet was washed with water, immersed in a 30 g/L sulfuric acid aqueous solution (liquid temperature: 30° C.) for 5 seconds for pickling, and then washed with water. The pretreated steel sheet was subjected to electrogalvanizing treatment thereby forming a galvanized layer on one side of the steel sheet at a coating weight of 20 g/m². For the electrogalvanizing treatment, a galvanizing bath filled with a zinc plating solution containing 440 g/L of zinc sulfate heptahydrate was used. The pH of the zinc plating solution was adjusted to 11.5 with sulfuric acid. The temperature of the galvanizing bath was 50° C. In the electrogalvanizing bath, the counter electrode was iridium oxide-coated Ti plate electrode, which was disposed in parallel with the test plate at a distance of 10 mm. A current was passed at a current density of 70 A/dm² with the plating solution circulated between the electrodes at a flow rate of 1.5 m/s.

As described above, a galvanized layer was formed on the steel sheet surface, washed with water, and then subjected to phosphate treatment.

As pretreatment before the phosphate treatment, the galvanized layer surface was treated with a surface conditioner (trade name “PREPALENE Z”, manufactured by Nihon Parkerizing Co., Ltd.). The galvanized layer was then sprayed with a phosphate treatment solution (a mixture of “PB3312M” manufactured by Nihon Parkerizing Co., Ltd. and magnesium nitrate) with the spraying time varied as appropriate, washed with water, and dried to form a phosphate film. The phosphate treatment solution had a temperature of 60° C., and a pH of 2.1 to 2.7, which differed among examples and comparative examples. All the treatment solutions contained Ni in an amount of 0.1 to 0.4g/L.

The Zn²⁺ concentration, Mg²⁺ concentration, and free acidity and total acidity in the phosphate treatment solution were varied as follows. The free acidity and total acidity in the examples and comparative examples were varied by controlling the concentration of “PB3312M” and adding as necessary a sodium hydroxide aqueous solution, orthophosphoric acid, and nitric acid. The Zn²⁺ concentration was varied by changing the initial concentration of “PB3312M”, and the Mg²⁺ concentration was varied by changing the content of magnesium nitrate.

The Mg content of the phosphate film was measured by dissolving the phosphate treated layer with an ammonium dichromate aqueous solution, and analyzing the solution by ICP (inductively-coupled plasma atomic emission spectrometry). The phosphate film coating weight was varied by changing the period of contact with the phosphate treatment solution. The phosphate film coating weight was measured by a gravimetric method using a solution of the film dissolved with an ammonium dichromate aqueous solution.

Table 1 lists the Zn²⁺ concentration, Mg²⁺ concentration, Mg²⁺/Zn²⁺ ratio, free acidity, total acidity, and free acidity/total acidity ratio in the phosphate treatment solution in each of the examples and comparative examples, and the Mg content and coating weight of the phosphate film on each of the phosphate-treated galvanized steel sheets.

The phosphate-treated galvanized steel sheets obtained as described above were subjected to various tests. The criteria for the tests conducted in the examples are described below.

(1) Appearance Uniformity

The surface appearance after the phosphate treatment was visually observed, and the uniformity after the phosphate treatment was evaluated on the basis of the following criteria:

◯: uniform appearance

x: nonuniform appearance

(2) Crystallization Condition

Crystallization condition was evaluated on the basis of the presence or absence of local vacancies of phosphate crystals in the phosphate film observed with SEM. Randomly chosen ten areas (100 μm×100 μm) in the central visual field on the 150×70 mm² specimen excluding the fringe areas of 20 mm from the edge of the specimen were observed with an electron microscope at a magnification of 1000, and the number of points having no phosphate crystal with a diameter of 20 μm was counted in each area. The average number of the points having no phosphate crystal counted in the ten areas was evaluated on the basis of the following criteria:

◯: less than 3

Δ: 3 or more and less than 10

x: 10 or more

(3) Corrosion Resistance

Corrosion resistance was evaluated as follows: a specimen (size: 100×50 mm) was cut out from each of the phosphate-treated galvanized steel sheets made above, and the edges and back side of the specimen were sealed with tape, and then subjected to the salt spray test according to JIS Z 2371-2000. The top surface of the specimen was periodically observed, and the time until the ratio of the white rust area became 5% with reference to the total measuring area on the specimen (white rust formation time) was measured, and evaluated on the basis of the following criteria:

⊙: 24 hours or more

◯: 8 hours or more and less than 24 hours

Δ: 4 hours or more and less than 8 hours

x: less than 4 hours

(4) Blackening Resistance

Blackening resistance was evaluated as follows: a specimen (size: 100×50 mm) was cut out from each of the phosphate-treated galvanized steel sheets made above, and the initial L value (lightness) of the specimen was measured using a spectroscopic color-difference meter SQ2000 (manufactured by Nippon Denshoku Industries Co., Ltd.). Subsequently, the specimen was allowed to stand for 24 hours in a constant temperature and humidity bath at a temperature of 80° C. and a relative humidity of 95%. After standing, the L value of the specimen was measured in the same manner, and the amount of change ΔL from the initial L value (L value after standing−initial L value) was calculated and evaluated on the basis of the following criteria:

⊙: ΔL≧−1

◯: −1>ΔL≧−2

Δ: −2>ΔL≧−4

x: ΔL<−4

(5) Coating Adhesion

Coating adhesion was evaluated as follows: a specimen (70×150 mm) was coated with an alkyd melamine-based paint (DELICON #700 manufactured by Dai Nippon Toryo Co., Ltd., dried at 130° C. for 30 minutes, film thickness: 28±5 μm) without pretreatment such as degreasing, incised with a cutter to make cross cuts (10×10 grid at intervals of 1 mm), and then subjected to Erichsen extrusion at a height of 5 mm. A piece of cellophane adhesive tape (type C LP-18) manufactured by Nichiban Co., Ltd. was affixed to the crosscut area after the Erichsen extrusion, and tightly contacted thereon using a spatula. Thereafter, the tape was removed, and the coating residual rate was measured and evaluated on the basis of the following criteria:

◯: 100%

Δ: 90% or more and less than 100%

x: less than 90%

Table 1 shows the results of the evaluation results in the above tests.

These results indicate that the phosphate-treated galvanized steel sheets of Examples 1 to 16 had favorable appearance uniformity, crystallization condition, corrosion resistance, blackening resistance, and coating adhesion, and that the quickly formed phosphate films also had sufficient performance.

TABLE 1

| | Phosphate treatment solution | | | | | | |
|---|---|---|---|---|---|---|---|
| | | | | | | Free | |
| | Zn²⁺ | Mg²⁺ | | | | acidity | Treatment |
| | concentration | concentration | Mg²⁺/Zn²⁺ | Free | Total | Total | time |
| Test No. | (g/L) | (g/L) | Concentration ratio | acidity | acidity | acidity | (second) |
| Example 1 | 3.5 | 2.5 | 0.71 | 2.1 | 22.0 | 0.095 | 4.5 |
| Example 2 | 3.3 | 3.0 | 0.91 | 1.6 | 20.7 | 0.077 | 4.2 |
| Example 3 | 3.1 | 4.1 | 1.32 | 1.9 | 20.1 | 0.095 | 4.8 |
| Example 4 | 3.0 | 2.4 | 0.80 | 1.3 | 21.0 | 0.062 | 5.3 |
| Example 5 | 3.1 | 2.0 | 0.65 | 2.1 | 25.1 | 0.084 | 10.5 |
| Example 6 | 3.5 | 2.8 | 0.80 | 2.4 | 26.3 | 0.091 | 11.2 |
| Example 7 | 4.5 | 3.6 | 0.80 | 2.4 | 25.0 | 0.096 | 10.4 |
| Example 8 | 3.0 | 4.5 | 1.50 | 2.1 | 23.0 | 0.091 | 5.2 |
| Example 9 | 2.5 | 2.8 | 1.12 | 0.9 | 26.0 | 0.035 | 4.5 |
| Example 10 | 3.1 | 4.5 | 1.45 | 2.2 | 24.0 | 0.092 | 4.5 |
| Example 11 | 4.5 | 2.1 | 0.47 | 2.2 | 25.0 | 0.088 | 3.0 |
| Example 12 | 2.5 | 3.3 | 1.32 | 2.5 | 26.0 | 0.096 | 3.8 |
| Example 13 | 2.1 | 4.1 | 1.95 | 2.1 | 23.0 | 0.091 | 3.0 |
| Example 14 | 3.1 | 4.1 | 1.32 | 1.9 | 20.1 | 0.095 | 16.0 |
| Example 15 | 3.1 | 4.1 | 1.32 | 1.9 | 20.1 | 0.095 | 30.0 |
| Example 16 | 3.1 | 4.1 | 1.32 | 1.9 | 20.1 | 0.095 | 2.5 |
| Comparative Example 1 | 1.8 | 2.5 | 1.39 | 1.3 | 20.0 | 0.065 | 2.9 |
| Comparative Example 2 | 5.1 | 5.2 | 1.02 | 3.1 | 24.0 | 0.129 | 10.8 |
| Comparative Example 3 | 3.1 | 2.4 | 0.77 | 2.8 | 22.0 | 0.127 | 4.5 |
| Comparative Example 4 | 3.2 | 0.1 | 0.03 | 2.1 | 22.0 | 0.095 | 10.5 |
| Comparative Example 5 | 2.1 | 2.0 | 0.95 | 0.5 | 26.0 | 0.019 | 19.0 |
| Comparative Example 6 | 2.1 | 5.2 | 2.48 | 2.2 | 23.0 | 0.096 | 10.5 |
| Comparative Example 7 | 5.1 | 3.2 | 0.63 | 2.1 | 28.0 | 0.075 | 25.0 |
| Comparative Example 8 | 3.2 | 2.6 | 0.81 | 4.3 | 29.0 | 0.148 | 30.0 |
| Comparative Example 9 | 2.1 | 6.2 | 2.95 | 2.2 | 23.0 | 0.096 | 15.0 |

| | | | | Crystalization | | | |
|---|---|---|---|---|---|---|---|
| | Phosphate film | | | condition | | | |
| | Mg content | Coverage | Appearance | (SEM | Corrosion | Blackening | Coating |
| Test No. | (mass %) | (g/m²) | uniformity | observation) | resistance | resistance | adhesion |
| Example 1 | 0.8 | 1.8 | ◯ | ◯ | ⊙ | ⊙ | ◯ |
| Example 2 | 0.9 | 1.9 | ◯ | ◯ | ⊙ | ⊙ | ◯ |
| Example 3 | 0.9 | 1.8 | ◯ | ◯ | ⊙ | ⊙ | ◯ |
| Example 4 | 0.8 | 1.7 | ◯ | ◯ | ⊙ | ⊙ | ◯ |
| Example 5 | 0.6 | 1.6 | ◯ | ◯ | ⊙ | ⊙ | ◯ |
| Example 6 | 0.9 | 2.1 | ◯ | ◯ | ⊙ | ⊙ | ◯ |
| Example 7 | 0.9 | 1.9 | ◯ | ◯ | ⊙ | ⊙ | ◯ |
| Example 8 | 1.1 | 1.7 | ◯ | ◯ | ⊙ | ◯ | ◯ |
| Example 9 | 0.8 | 1.6 | ◯ | ◯ | ⊙ | ⊙ | ◯ |
| Example 10 | 1.8 | 1.9 | ◯ | ◯ | ⊙ | ◯ | ◯ |
| Example 11 | 0.3 | 1.5 | ◯ | ◯ | ◯ | ⊙ | ◯ |
| Example 12 | 1.3 | 1.9 | ◯ | ◯ | ⊙ | ◯ | ◯ |
| Example 13 | 1.9 | 1.2 | ◯ | ◯ | ◯ | ◯ | ◯ |
| Example 14 | 0.9 | 2.5 | ◯ | ◯ | ⊙ | Δ | ◯ |
| Example 15 | 0.9 | 2.6 | ◯ | ◯ | ⊙ | Δ | Δ |
| Example 16 | 0.9 | 1.5 | ◯ | Δ | ◯ | ◯ | ◯ |
| Comparative Example 1 | 0.8 | 0.9 | X | Δ | X | Δ | Δ |
| Comparative Example 2 | 1.1 | 1.9 | X | X | Δ | ◯ | Δ |
| Comparative Example 3 | 0.9 | 1.9 | ◯ | X | Δ | ◯ | ◯ |
| Comparative Example 4 | 0.2 | 1.8 | ◯ | ◯ | X | ◯ | ◯ |
| Comparative Example 5 | 0.5 | 1.9 | X | X | X | ◯ | Δ |
| Comparative Example 6 | 1.9 | 2.1 | X | X | ◯ | ◯ | Δ |
| Comparative Example 7 | 0.8 | 1.9 | X | X | Δ | ◯ | Δ |
| Comparative Example 8 | 0.8 | 1.6 | X | X | ⊙ | ⊙ | ◯ |
| Comparative Example 9 | 2.2 | 2.1 | X | X | ◯ | ◯ | Δ |

### INDUSTRIAL APPLICABILITY

According to the making method of the present invention, a uniform phosphate film is quickly formed, and thus a phosphate-treated galvanized steel sheet superior to known anticorrosive coated steel materials in corrosion resistance and blackening resistance is obtained. The phosphate-treated galvanized steel sheet is widely useful as a steel substrate to be coated for building and home appliance applications, and thus markedly contributes to the industry.

1. A method for making a phosphate-treated galvanized steel sheet comprising forming a phosphate film on the surface of a galvanized layer of a galvanized steel sheet using a phosphate treatment solution containing Zn²⁺ and Mg²⁺ so as to satisfy 2.0<Zn²⁺≦5.0 g/L, 2.0≦Mg²⁺≦5.0 g/L, and 0.4≦Mg²⁺/Zn²⁺≦5 2.5, and satisfying 0.020≦free acidity/total acidity<0.10.

2. The making method of claim 1, wherein the phosphate film is formed by contacting the galvanized layer surface with the phosphate treatment solution for 3 to 15 seconds.

3. A method for making a phosphate-treated galvanized steel sheet comprising treating a galvanized steel sheet with a phosphate treatment solution to form a phosphate film on the surface of the galvanized steel sheet, wherein the phosphate treatment solution contains Zn²⁺ in an amount of more than 2.0 g/L and 5.0 g/L or less, Mg²⁺ in an amount of from 2.0 to 5.0 g/L, the concentration ratio of the Mg²⁺ to Zn²⁺ (Mg²⁺/Zn²⁺_{) is from} 0.4 to 2.5, and the ratio of the free acidity to the total acidity in the treatment solution is 0.020 or more and less than 0.10.
